(19) United States
(12) Patent Application Publication
(10) Pub. No.: US 2014/0379433 A1
(43) Pub. Date: Dec. 25, 2014

(54) Method and System for Automatic Generation of an Offer to Purchase a Valuable Object and Automated Transaction Completion

(71) Applicant: I Do Now I Don't, Inc., New York, NY (US)

(72) Inventor: Josh Opperman, New York, NY (US)

(21) Appl. No.: 13/929,629

(22) Filed: Jun. 27, 2013

Related U.S. Application Data
(60) Provisional application No. 61/837,592, filed on Jun. 20, 2013.

(51) Int. Cl. G06Q 30/02

(52) U.S. Cl. CPC G06Q 30/0206; G06Q 30/0283
USPC 705/7.35

(57) ABSTRACT

This invention discloses a novel system and method for automatically determining the price to offer to purchase a valuable object, for example, jewelry or watches, and then an automated system to enter into a binding purchase agreement and to fulfill the purchase with an insured shipment of the object to the buyer.

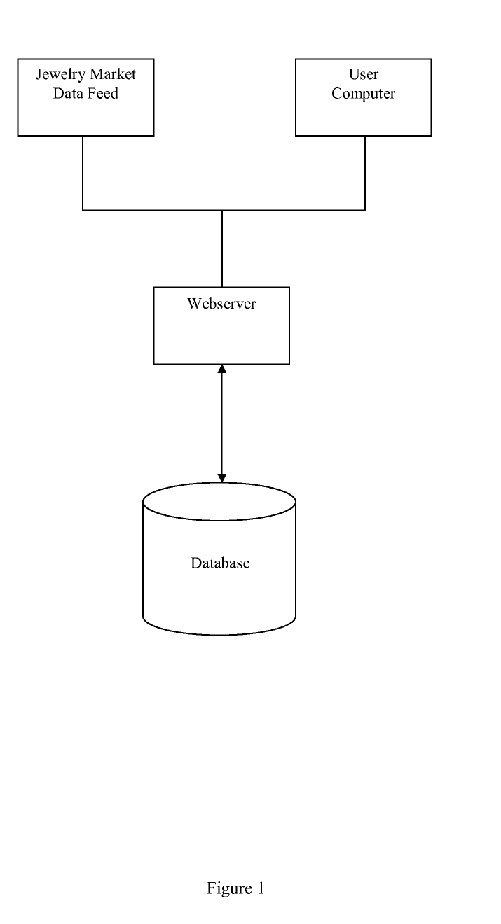

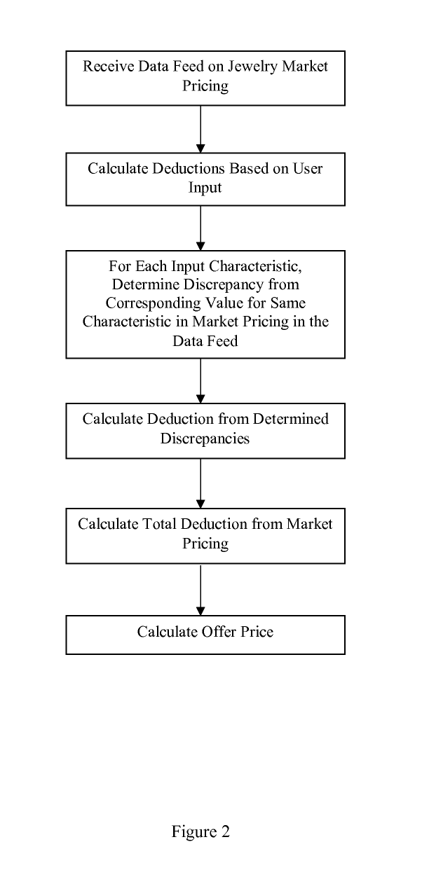

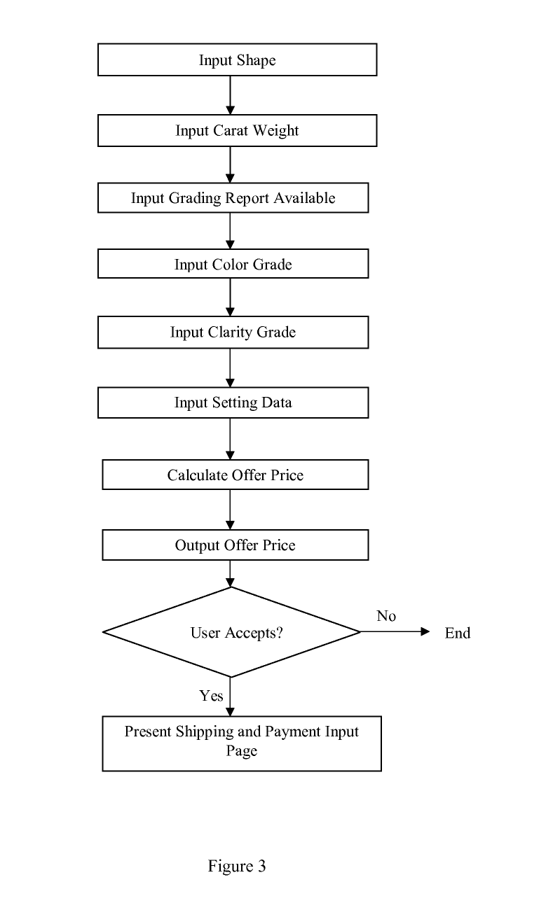

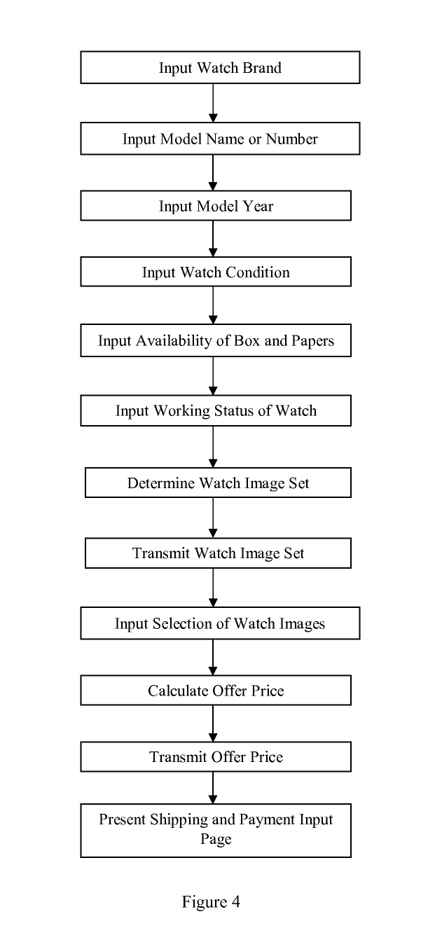

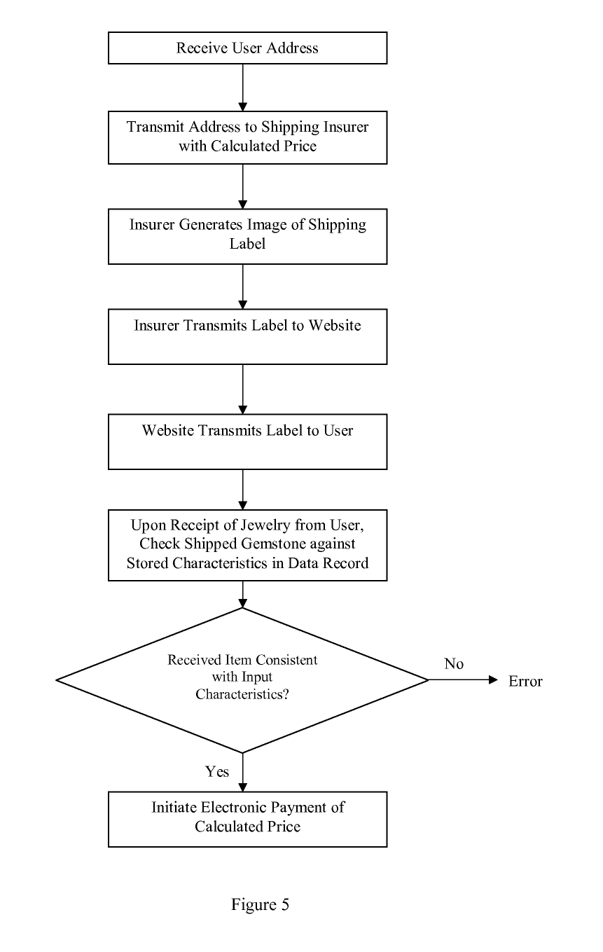

### PRIORITY CLAIM

This application claims priority as a non-provisional continuation of U.S. Provisional Application No. 61/837,592 filed on Jun. 20, 2013, which is herein incorporated by reference in its entirety.

### FIELD OF INVENTION

This invention provides a mechanism whereby a customer can automatically obtain a binding offer to purchase a piece of jewelry or a watch from a website and cause such website to automatically complete the purchase.

### BACKGROUND

Persons who possess valuable precious assets, for example, jewelry or watches, often seek to sell the assets for cash. Typically, the owner has to take the asset to a storefront where someone can examine the object and then make an offer to purchase it. This requires finding such a shop and further, trusting that the shop operating the storefront can make good on the purchase price. This is time consuming and involves a level of trust that may be absent in a small store-front. The invention claimed here is for a system that provides a website that permits the user to input aspects of the precious asset so that the system can automatically calculate an offer price. If the price is acceptable to the user, the website will automatically arrange for insured shipping of the asset and payment of the purchase price to the selling user. One aspect of the invention is how the website system automatically calculates a price for the precious asset being offered. Another aspect is how the system completes the transaction.

### DESCRIPTION OF THE FIGURES

1. Basic System Architecture

2. Flow Chart for Price Calculation

3. Flow Chart for Data Acquisition for Gemstone Pricing

4. Flow Chart for Data Acquisition for Watch Pricing

5. Flow Chart for Transaction Processing.

### DETAILED DESCRIPTION OF THE PREFERRED EMBODIMENTS

The method and system operates on one or more computers, typically using a server and one or more remote user's computing devices. A customer's device can be a personal computer, mobile phone, mobile handheld device like a Blackberry™ or iPhone™ or a tablet device like the iPad™ or Galaxy™ or any other kind of computing device a user can use to view and edit an electronic document. The user devices are operatively connected to the remote server using a data network. They typical user is someone who owns jewelry or a watch that they seek to sell. In one embodiment, the user accesses the system by means of an Internet browser software operating on their local computing device. The typical user establishes a user identifier with the system by inputting a user name and a password. This is used by the system for tracking the user's data. The browser interacts with the website server in order to provide a mechanism for the system to receive specific information about the jewelry or watch. In another embodiment directed to jewelry, the user operates a set of selection menus that display drawings of typical gemstone cuts and provides a selection mechanism that the user can actuate. By means of this user interface, the user can input characteristics of the gemstone, including: shape, carat weight, whether a grading report is available, color grade, clarity grade, and information about the setting. The system then stores this data into a data record that is associated with the user's identifier.

In another embodiment, the user is prompted for information about the watch they seek to sell. In this case, the user interface obtains information from the user including: watch brand, model number, model year, condition, availability of box or certification papers, working status. The system uses some or all of this information to search in a database to recover a set of at least one images of watches that are determined to be candidates for the identity of the user's watch. These images are transmitted to the user's computer device and displayed on the computer's screen. The user interface presented by the browser then takes as input a selection by the user of one of the images that most closely matches the user's watch. The system then stores all of this input data into a data record that is associated with the user's identifier.

In yet another embodiment, the system is designed to use image recognition to determine the type of watch subject to the sale offer. In this embodiment, the user interface permits the user to input an image file that is a picture of the watch. Alternatively, an email address may be provided that is associated with the transaction and the person can use a portable device that has a digital camera and email capability to photograph the watch and transmit the image to the system. The system database would contain data records that are comprised of watch images, which are associated with other data, for example, the manufacturer, model and model year. The data record may also have data representing image features extracted from the image that can be used for automated image matching. In this embodiment the received image is processed to extract particular features from the image that can be used to search the database of watch images to find the closest matching images. These close matches will be used to select actual images that are transmitted to the user's browser for presentation. The user can then confirm which watch is the exact match. In another embodiment, the system relies on its best match determination. In this manner, the watch brand, model and model year is obtained without the user having to manually input all of the watch brand, model and model year particulars.

When the user has input the jewelry characteristics in the system, the system can then calculate the offer price. This is accomplished by the system monitoring data that it receives from one or more gemstone trading markets that distribute trade pricing electronically. In one embodiment, the market data is for diamonds and the market rates for diamond trading from the Rap Report™. In this embodiment, the system inspects the market pricing data to locate a gemstone price that most closely matches the gemstone input by the user. However, the market pricing data may be for a gemstone of higher or lower quality than the user's gemstone. The system then obtains a set of predetermined price adjustment factors that correspond to each characteristic that is different about the user's gemstone as compared to the gemstone called out in the market data. For example, a high value diamond whose trade price is called out in the data may be of the same weight as the user's diamond, but the color of the market diamond may be blue while the user's diamond is yellow. The system them obtains from its database a predetermined discount factor that corresponds to a discrepancy in color from blue to yellow. All of the discount adjustments are determined by comparing all of the characteristics. An offer price can then be calculated by applying the entire set of discounts to the market price value. This can be done by calculating a series of factors: the market price is multiplied by all of the discounts to arrive at the offer price. In the typical embodiment for diamonds, the market pricing report will provide an exact match for an input or color, clarity, cut, shape and weight of a diamond. The deductions will apply for characteristics of type of certificate, cut grade, fluorescence, type of gold in setting, and brand source of the jewel. Once the offer price is calculated by the system, the system transmits the offer price to the user's computer for display on the browser.

In the embodiment of the invention applied to valuable watches, the system obtains data feeds from on-line market places that offer used watches for sales. In one embodiment, two API feeds interface the system to market places available on Amazon™ and Google™. In this embodiment, characteristics of the user's watch are used to scan for similar watches with offered or quoted prices. In the preferred embodiment, special deduction rules are applied to certain brands, that is, the deduction for watch condition may be different for a Rolex™ as compared to another brand of watch. In this embodiment, the system database has a matrix for the deduction factors, where the rows are for the characteristic type and column for the applicable brand. In another dimension can be the amount of discrepancy with individual entries for each factor in that case. As with the jewelry price calculator, the offer price for the watch is calculated by multiplying the discount factors times the market price detected from the market data feeds.

In one embodiment, the data input by the user is used to determine a vector, whose elements are pairs of numbers, one being a reference to a type of attribute and the other to the amount of discount. The vector is then stored in a database associated with the transaction. The data associated with the nearest matching gemstone in the market data feed can be used to create a vector for that market point. The two vectors can be subtracted on an element by element basis. Where the attributes are the same, there is a zero for the result vector element. In the other position, a difference is held. A third vector is created that is the set of discount factors corresponding to the types of attributes. This discount vector is then vector multiplied with the result vector as described below to calculate a single discount number to apply to the market price of the market gemstone. Where the difference elements are zero, no discount component applies, so the discount for that element is zero. Where the difference elements are non-zero, the discount factor for that element gets multiplied by the difference in the attribute value to obtain a discount for that element. When all of the discount elements for the individual attributes are calculated, the non-zero discount elements are multiplied to arrive at a single discount that applies to the entire price.

The system transmits the offer price for the jewelry or watch to the user after it is calculated. The user interface then permits the user to actuate buttons that encode whether the user accepts or rejects the offer. The browser transmits this encoded response to the central servers comprising the system. The system causes the browser to display input boxes in order that the user input their name and address, email address and any other information necessary to complete the transaction. This may also include the form of payment the seller seeks, and any relevant account data necessary to effectuate electronic payment of the purchase price. The system also transmits for display a click-through agreement to the user that expresses the purchase agreement to sell the jewelry or watch. If the user clicks an “ACCEPT” button, then this is stored in the data record. In another embodiment, the user takes a picture of the jewelry and transmits it to an email address portal that is specific to this transaction. The system then receives the image file and then stores it in the database in a record associated with the user identifier.

Once a purchase agreement has been entered into electronically, and shipping information provided by the user, the purchase transaction then moves to automated fulfillment. In this case, the system transmits the relevant user information to a third party system operated by a party that provides insurance for the shipping of the jewelry or watch. The transmitted information may include the name and address of the seller, the relevant information about the jewelry or watch and the amount of the offer price. The third party system can then procure insurance for the shipment and generate a shipping label for the shipment that includes the destination address of the entity actually buying the jewelry or watch. This is an image that can be printed out on a computer printer and used by typical courier services that ship small objects. The shipping label image is transmitted to the system, which then transmits it on to the user's computer, either as an email attachment or through the browser providing a hyperlink to the document. The user can then print the label and use it to ship the jewelry or watch to the buyer operating the system.

In one embodiment, the insuring system is operated by Parcel Pro™. The automatic purchasing system invention accesses this third party's systems through an API in order to fetch a Fed Ex™ shipping label, which is then transmitted to the selling user as an email attachment. As soon as the request for a shipping label is submitted, an amount for an insurance premium determined and the insurance is associated with the serial number of the shipping label. When the shipping label is used, that is, when it is scanned by Fed Ex™ personnel accepting the package for shipment, Fed Ex™ transmits notice to Parcel Pro™ who then charges the buyer the insurance premium.

When the package arrives from the seller, the package is opened and inspected. A person operating a computer accesses the system database and inputs the shipping label number. This brings up the purchase transaction information. The person can then inspect the jewelry or watch and check whether the unit in hand matches what was purported to be subject to the sale transaction as described by the data in the database. If there is a sufficient match, then the person can click an acceptance button on the user interface. This causes the system to automatically process payment to the selling user, through any kind of electronic payment mechanism, including credit card, PayPal™, ACH or other techniques.

Operating Environment:

The user's computer may be a laptop, desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The system and method described herein can be executed using a computer system, generally comprised of a central processing unit (CPU) that is operatively connected to a memory device, data input and output circuitry (I/O) and computer data network communication circuitry. A video display device may be operatively connected through the I/O circuitry to the CPU. Components that are operatively connected to the CPU using the I/O circuitry include microphones, for digitally recording sound, and video camera, for digitally recording images or video. Audio and video may be recorded simultaneously as an audio visual recording. The I/O circuitry can also be operatively connected to an audio loudspeaker in order to render digital audio data into audible sound. Audio and video may be rendered through the loudspeaker and display device separately or in combination. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A system for automatically selling a valuable object comprising:
An input module adapted to receive data describing a plurality of characteristics of the object being sold;
A market data feed component adapted to receive pricing data for similar objects to that subject to the sale;
A database adapted to store a plurality of discount factors corresponding to the characteristics; and
A price calculating component adapted to determine an offer price in dependence on determining discount factors applicable to the object being sold in dependence on the received pricing data.

2. The system of claim 1 further comprising:
A fulfillment component adapted to procure an insurance contract for shipment of the object being sold, receive a shipping label for the shipment and to transmit the shipping label.

3. The system of claim 1 where the valuable object is comprised of a gemstone.

4. The system of claim 1 where the valuable object is comprised of a watch.

5. The system of claim 3 where the input module is adapted to receive at least one of: gemstone shape, gemstone carat weight, availability of a gemstone grading report, gemstone color grade, gemstone clarity grade, and information about the gemstone's setting.

6. The system of claim 4 where the input module is adapted to receive at least one of: watch brand, watch model number, watch model year, watch condition, availability of box or certification papers and watch working status.

7. The system of claim 1 where the price calculating component is further adapted to select a gemstone trade price from the market data feed in dependence on at least one of the input characteristics of the object subject to sale, determine which characteristics are different between the gemstone described in the selected gemstone trade data and the characteristics of the object subject to sale, in dependence on such determination, recover from the database discount factors corresponding to the determined characteristics, calculate an offer price by multiplying the recovered discount factors times the selected trade price, store the offer price in a computer memory and transmit the offer price to a remote computer.

8. The system of claim 4 where the input module is adapted to receive an image of the watch and the database component is adapted to use the received image to determine at least one of the brand, model and model year of the watch.
